(19) United States
(12) Patent Application Publication
(10) Pub. No.: US 2007/0251243 A1
(43) Pub. Date: Nov. 1, 2007

(54) Thermally stabilized sensors for cooled electrical packages

(76) Inventors: John M. Geary, Macungie, PA (US); John E. Johnson, Schnecksville, PA (US); Len Ketelsen, Clinton, NJ (US); David J. Lischner, Allentown, PA (US); Thomas Miller, Frisco, TX (US)

Correspondence Address: Law Firm of Peter V.D. Wilde, 301 East Landing, Williamsburg, VA, 23185, US

(21) Appl. No.: 10/939,799

(22) Filed: Sep. 13, 2004

(51) Int. Cl. F25B 21/02; G05D 23/30; F25D 23/12

(52) U.S. Cl. 62/3.7; 62/259.2; 62/202

(57) ABSTRACT

Described is a thermally stabilized sensor for cooled component packages. A cooled component package includes a cooled component, a temperature-sensing device located adjacent to the cooled component, and a heat flow modifier located adjacent to the temperature-sensing device. Examples of the heat flow modifier include a ground shield, a wire bonded to platform upon which the cooled component is mounted, and a bonding layer between a refrigerator element and an optical subassembly that includes the cooled component.

### FIELD OF THE INVENTION

This invention relates to electronic device packages in which components are actively cooled. More specifically it relates to managing the thermal ambient for the sensing device used to control the cooling assembly.

### BACKGROUND OF THE INVENTION

Some types of devices used in electronic circuit packages require controlled temperature to avoid degradation, failure, or to meet functional requirements. Common among these are semiconductor laser packages where optical-wavelength stability and the lifetime of the laser diode are significantly enhanced if the diode is maintained at a moderate uniform temperature, typically below 40° C. Accordingly, these devices are often provided with active cooling elements, usually thermoelectric cooling (TEC) devices.

Normally, TEC devices are also hermetically sealed to provide additional environmental control. Common hermetic packages comprise a sealed ceramic and/or metal container in a box-like configuration. The I/O leads from the TEC device pass through holes in the container walls, and are sealed with welding, epoxy, solder, or other suitable seal. In the description below these device packages are referred to as TEC packages. The primary device category of interest for TEC packages are optoelectronic device TEC packages. Although the description below focuses on TEC devices for the cooling device, other refrigerator devices may be substituted.

A typical TEC package may contain a variety of components. The most temperature sensitive devices are cooled using the TEC device. These are referred to herein as cooled components. Other components in the package may not require cooling. Thus the TEC package may have one or more sections where the TEC cooling is focused.

It is conventional to mount the cooled components on a subassembly platform. In an optical device this is referred to as the optical subassembly (OSA) platform. A temperature-sensing device, typically a thermistor, is mounted on the OSA platform. The assumption is that the temperature of the OSA platform is the same as the temperature of the cooled components. As seen below, this assumption is not always valid.

The environments in which these packages are used vary widely, and adverse or hostile environments are not uncommon. Most customer specifications require the devices to operate effectively in relatively hot temperature environments, e.g. as high as 75 or 80° C. The need for active cooling of heat sensitive components in a package exposed to these temperatures is well established.

For example, in a laser package, temperature control of the laser is needed to control laser wavelength and improve laser reliability. Heat flowing between the walls and other elements of the package and the TEC device can cause the actual temperature of the laser arid the temperature indicated by the temperature-sensing device to diverge in a manner that is dependent on both the laser and package wall temperature. The package wall temperature typically may vary from −5° C. to +85° C. This difference (divergence) in temperature can cause unwanted shifts in laser wavelength. This shifting is known as wavelength tracking error. To control this effect, temperature control of the laser is desirably controlled to within+/−1° C., and preferably within 0.2° C.

Miniaturization of electronic components and packages impacts the performance of cooling devices. As the package size shrinks, the free volume within the package is reduced. This creates new heat flow patterns among elements in the package, between the packaged elements and the package walls, and between the packaged elements, the package walls, and the temperature sensing device.

An aggravating condition is introduced with respect to the temperature-sensing device(s). In a relatively open (large) package design the sensing. device can reliably record the temperature of the OSA, and that reading reliably indicates the temperature of the component being cooled. However, as the void space in the package shrinks, the sensing device now “sees” other elements and records false temperatures, i.e. temperatures that do not reflect the temperature of the cooled component. This result may be acceptable in a package with elements in temperature equilibrium, but in a cooled package that is not the case.

Consequently, managing the thermal environment for the temperature-sensing device(s) in a cooled package presents a new challenge.

### BRIEF DESCRIPTIONS OF THE DRAWINGS

The invention may be better understood when considered in conjunction with the drawings in which:

FIG. 1 is a schematic view of a portion of an illustrative prior art TEC package;

FIG. 2 is a schematic view of a portion of an illustrative TEC package with a heat shield heat flow modifier illustrating a first embodiment of the invention;

FIG. 3 is a view of a portion of a TEC package with a “grounded” lead heat flow modifier illustrating a second embodiment of the invention; and

FIG. 4 is a view of a portion of a prior art TEC package having an attachment layer between the TEC and the optical subassembly; and

FIG. 5 is a view of a modified attachment layer heat flow modifier illustrating yet another embodiment of the invention.

### DETAILED DESCRIPTION OF THE INVENTION

Various thermo-mechanical solutions are described herein for improved control over the thermal ambient of the temperature-sensing device in a cooled component package. These employ expedients in the design of the package that are intended to modify the heat flow in the vicinity of the temperature-sensing device and laser. Heat flow modifier is the term applied to an element in the TEC package that is primarily designed to modify heat flow in the vicinity of the temperature-sensing device and laser, and is incorporated in the TEC package for that purpose.

One example of a heat flow modifier is the following. A heat shield that at least partially surrounds the temperature-sensing device and intercepts heat before reaching the temperature-sensing device. Another example is electrical leads that extend from the temperature-sensing element to the outside of the package, which are “grounded” on the OSA platform to reduce heat flow to the temperature-sensing element through the electrical connections. It will be understood by those skilled in the art that the term “grounded” is used here in a thermal, not an electrical, context, and ground is a reference temperature in contrast to a reference voltage. Yet another example is the bonding layer between the OSA and the TEC device that may be modified to similarly reduce the laser-to-temperature sensing device temperature divergence, and thus reduce the wavelength tracking error. The usual bonding layer is a uniform layer of solder. If the geometry of that layer is modified, for example is made in a stripe configuration, wavelength tracking error is reduced.

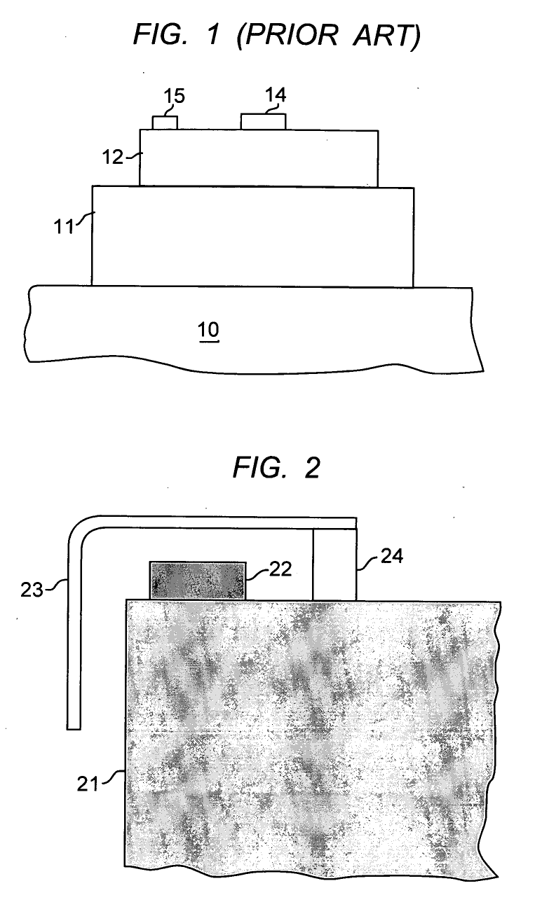

FIG. 1 shows an example of a portion of a prior art cooled optoelectronic package where a cutaway portion of the overall package substrate is shown at 10. Typically the optoelectronic package substrate is a ceramic or metal substrate. Mounted on substrate 10 is a refrigerator device 11, typically, but not limited to, a TEC device, or simply TEC. For purposes of discussion and ease of explanation, refrigerator device 11 will be referred to hereinafter as a TEC device or TEC. Mounted on the TEC is an OSA. The OSA comprises an OSA platform 12 that supports the cooled components and provides suitable interconnections.

In the OSA described herein, the cooled component is laser 14.

Monitoring the temperature of laser 14 is temperature-sensing device 15, typically a thermistor. The TEC, the OSA and other components are enclosed in a hermetically sealed container (not shown). The container is typically, but not limited to, a metal or ceramic box, and electrical connections to the OSA are routed through the container walls and connected to the OSA elements within, typically using, but not limited to, wire bond interconnections.

FIG. 2 shows one embodiment of a cooled component package with a heat shield heat flow modifier associated with the temperature-sensing device. In FIG. 2 the OSA platform is shown at 21 and the temperature-sensing device is shown at 22. (The cooled component does not appear in this view.) The heat flow modifier in this embodiment is heat shield 23, which extends at least partially around the temperature-sensing device 22. The heat shield 23 is attached to the OSA platform 21 by support 24. Both heat shield 23 and support 24 are made from a thermally conductive material such as aluminum or copper. However, a variety of materials may be substituted. The support 24 in this embodiment is simply a convenient attachment and support means. Alternatively, the heat shield 23 may be shaped so as to allow direct attachment, by solder or other bonding agent, to the OSA platform 21.

The thermally conductive heat shield, placed in the manner shown, functions in at least two ways to stabilize the temperature of the temperature-sensing device relative to the laser. First, it protects the temperature-sensing device from variable heat flow from other elements in the hermetic package, including but not limited to heat flow from the ambient and package walls.

Second, because it is attached to the OSA platform, it is maintained at or close to the temperature of the OSA platform, so that the temperature-sensing device is exposed on all sides to bodies maintained at the OSA temperature. The heat shield is shown and described herein as at least partially surrounding the temperature-sensing device. It may also comprise a housing or can that covers the temperature-sensing device. It may also comprise a housing that simultaneously covers the temperature sensing device and laser.

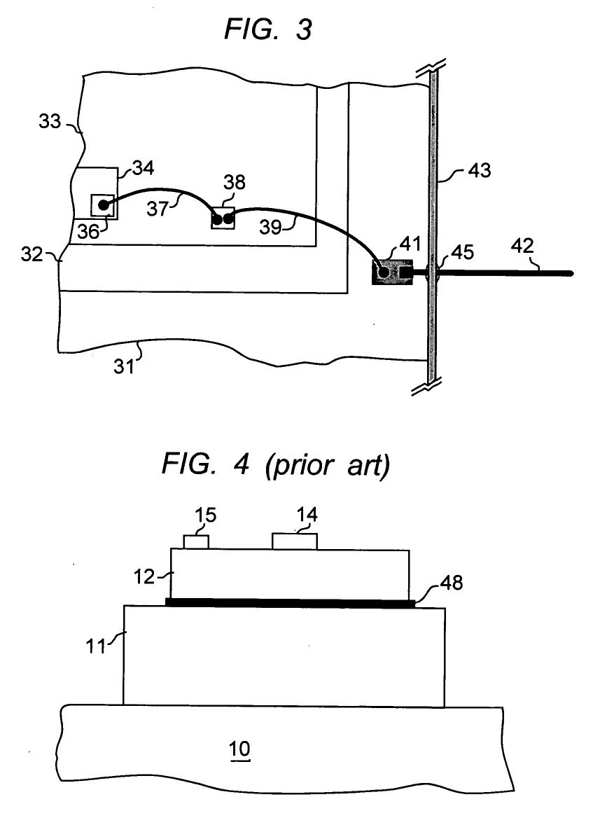

FIG. 3 shows another embodiment of a heat flow modifier. This view shows the hermetic package wall, or simply wall, 43, with conductor pin 42 extending through the wall 43. The substrate is shown at 31, and the TEC is shown at 32. The OSA platform is designated 33, and the temperature-sensing device 34. (The cooled component does not appear in this view.) The wall 43 in the figure is only a portion of one wall of the TEC package, and only one conductor pin is shown for simplicity. The pin openings in the wall 43 are sealed with brazing, solder, epoxy, laser welds, or other suitable means 45. An example of the type of hermetic package illustrated is a 14-pin butterfly package. For the purpose of illustrating the invention only the lead to the temperature-sensing device 34 is shown in detail.

In the prior art device shown in FIG. 1, the wire bonds from the package wall would be routed directly to the temperature-sensing device. In the prior art arrangement an effective path would be available for heat flow from the wall to the temperature-sensing device, and would allow heat from the wall, or heat from an element between the wall and the OSA, to be “piped” to the temperature-sensing device.

In the arrangement shown in FIG. 3, a wire bond 37 contacts the bond pad 36 on the temperature-sensing device 34, is routed to the surface of the OSA platform 33, and bonded to bond pad 38 on the OSA platform 33. This bond acts as a thermal “ground”, with the thermal reference point the temperature of the OSA. It prevents a direct path for heat flow from wall 43 to the temperature-sensing device 34. There may also be an intermediate bonding site, such as bond pad 41. It will be appreciated by those skilled in the art that bond pad 38 is a “passive” bond pad, i.e. its main purpose is not electrical but is to serve the heat flow modifier for the temperature-sensing device 34. Pad 34 may be omitted.

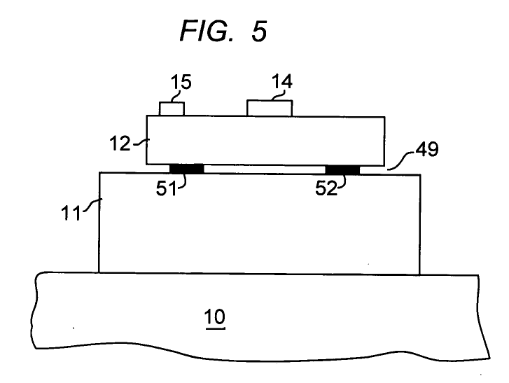

FIG. 4 shows a prior art OSA mounting arrangement that includes an attachment layer 51 between the OSA and the TEC. In FIG. 5, where like reference numerals refer to similar elements in FIG. 4, the bottom surface of the OSA platform 12 (or the top surface of the TEC 11) is metallized, typically with a layer of solder, to form attachment layer 48. The attachment layer 48 is continuous, as shown, to maximize heat flow from the OSA platform 12 to the TEC 11. The attachment layer 48 can be modified to change the heat flow pattern among elements in the heat flow package. Wavelength tracking error in laser 14 is actually reduced if the heat flow across attachment layer 48 is modified.

FIG. 5 shows an embodiment of a heat flow modifier where the attachment layer 49 is made using stripes 51 and 52. In FIG. 5, where like reference numerals refer to similar elements in FIG. 4, two stripes are shown by way of example, but any number may be used. Other configurations, for example one or more whole or partial rings, or one or more whole or partial picture frames, may be used to control the area of the thermal contact between the OSA 12 and the TEC 11. The geometry of the bonding layer is easily configured by selective application of an adhesive or by using a suitable selective area solder application technique, e.g., shadow mask evaporation.

The term TEC is used repeatedly in this description but it will be understood that any kind of cooling device may be used in place of, or in addition to, a thermoelectric element. The terms “refrigerator” and “refrigerator element” may be used as a more generic descriptor. As mentioned before, the term cooled component is intended as meaning any electrical component that has an active cooling element(s) associated therewith. A cooled component package is a cooled component in a container housing. The package may comprise one or more TEC elements. The cooled component is typically a laser but may be any electrical device the performance of which is affected by temperature. The temperature-sensing device is typically a thermistor but may be any suitable device where an electrical signal output from the sensor varies with temperature.

In the embodiments shown, the temperature-sensing element is attached to the OSA platform. Other arrangements may be found suitable. In the embodiments shown, the temperature-sensing element can be located adjacent to the cooled component. “Adjacent” is meant to define a nearby or touching relationship. Likewise the cooled component, while normally affixed to the refrigerator, may be located adjacent to the refrigerator.

Various additional modifications of this invention will occur to those skilled in the art. All deviations from the specific teachings of this specification that basically rely on the principles and their equivalents through which the art has been advanced are properly considered within the scope of the invention as described and claimed.

1. A cooled component package comprising:
a cooled component,
a temperature-sensing device located adjacent to the cooled component, and
a heat flow modifier located adjacent to the temperature-sensing device.

2. The cooled component package of claim 1 wherein the heat flow modifier comprises a heat shield.

3. The cooled component package of claim 2 wherein the heat shield comprises metal.

4. The cooled component package of claim 2 wherein the heat shield at least partially surrounds the temperature-sensing device.

5. The cooled component package of claim 1 wherein the cooled component is part of an optical subassembly (OSA) including a platform, and the cooled component is mounted on the platform.

6. The cooled component package of claim 5 wherein the heat flow modifier comprises a heat shield, and wherein the heat shield is attached to the platform.

7. The cooled component package of claim 5 wherein the heat flow modifier comprises a wire bonded to the platform.

8. The cooled component package of claim 7 wherein the wire bonded to the platform comprises an electrical lead to the temperature-sensing device.

9. The cooled component package of claim 7 further comprising:
a package housing enclosing the OSA platform; and
an electrical connection between the wire bonded to the platform and the package housing.

10. The cooled component package of claim 6, further comprising a refrigerator element located adjacent to the cooled component, wherein the OSA is supported by the refrigerator element.

11. The cooled component package of claim 10, wherein the heat flow modifier comprises a bonding layer between the refrigerator element and the OSA.

12. The cooled component package of claim 11 wherein a surface of the OSA is bonded to the refrigerator element, the surface has area A, and the bonding layer has an area less than A/2.

13. The cooled component package of claim 11 wherein the bonding layer comprises two or more conductive stripes.

14. The cooled component package of claim 11 wherein the bonding layer comprises at least one full or partial conductive ring.

15. The cooled component package of claim 11 wherein the bonding layer comprises solder.

16. The cooled component package of claim 10, wherein the refrigerator element comprises a thermo-electric cooler.

17. The cooled component package of claim 1 wherein the cooled component is an optoelectronic device.

18. The cooled component package of claim 17 wherein the cooled component is a laser.

19. The cooled component package of claim 2 wherein the heat shield at least surrounds the temperature sensing device and laser.
